(19) United States
(12) Patent Application Publication
(10) Pub. No.: US 2004/0201816 A1
(43) Pub. Date: Oct. 14, 2004

(54) Method and structure for broadening cholesteric liquid crystals spectrum

(76) Inventors: Yu-Wen Chen, Kaohsiung (TW); Chuen-Ru Lee, Taoyuan (TW); Szu-Fen Chen, Taoyuan (TW); Sheng-Shiung Hou, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/819,847

(22) Filed: Apr. 8, 2004

(30) Foreign Application Priority Data
Apr. 9, 2003 (TW) 92108175

(51) Int. Cl. G02F 1/133

(52) U.S. Cl. 349/175

(57) ABSTRACT

A method and structure for broadening cholesteric liquid crystals spectrum are described. An electrode structure is added on a side of cholesteric liquid crystals, for producing a fringe field which is perpendicular to a screw axis of the cholesteric liquid crystal. Hence, the thread pitches of cholesteric liquid crystals near the electrode structure are lengthened, but the other thread pitches of cholesteric liquid crystals far from the electrode structure remain the same. Besides, light having appropriate wavelength is used to congeal the cholesteric liquid crystals having a polymeric characteristic, so that the cholesteric liquid crystals have varied thread pitches while no voltage is applied to the electrode structure. Therefore, the spectrum of cholesteric liquid crystals and applications thereof are widened.

### BACKGROUND OF THE INVENTION

1. Field of Invention

The present invention relates to liquid crystal display technology. More particularly, the present invention relates to a method and a structure for broadening a cholesteric liquid crystal spectrum.

2. Description of Related Art

In general, a substance exists in nature in a solid, liquid or gaseous phase. A solid further may be in either a crystalline state or amorphous state. From a macro-view, the molecules in crystalline solid are regular. However, when the crystalline solid is heated to a temperature above a melting point, the arrangement of molecules in the crystalline solid loses orientational order, and the crystalline solid becomes an isotropic liquid.

Nevertheless, some organic materials do not change directly from the solid to liquid phases when heated. Rather, they pass through one or more mesomorphic phases between the solid and liquid phases. Substances having a mesomorphic phase possess orientation order and anisotropy like a solidas well as spatial disorder and flowing characteristic like a liquid, and their dynamics, optics and symmetry are also between the solid and liquid phases. Thus, this mesomorphic phase is called the liquid crystal phase.

Liquid crystals may be classified into three types as described in the following:

(1) nematic liquid crystals: molecules of the nematic liquid crystals are stick shaped and parallel in arrangement, and axes of the molecules are also arrange in parallel. But nematic liquid crystals do not have layering structures as smectic liquid crystals do. Nematic liquid crystals have following characteristics of smectic liquid crystals, but with less viscosity due to the easier movement on the long axes.

(2) smectic liquid crystals: molecules of smectic liquid crystals have layering structures. Each molecule of a smectic liquid crystal is perpendicular or sloped to the surface of the layering structure and arranged parallel to each other. The smectic liquid crystals are sticky and thick like oil, and have the ability to polarize light.

(3) cholesteric liquid crystals: cholesteric liquid crystals are usually formed by adding a chiral dopants into a nematic host. The cholesteric liquid crystals have a layering structure like that smectic liquid crystals, but the long axes of the molecules are arranged in parallel, similar to those of nematic liquid crystals. In the cholesteric liquid crystals, axes of molecules have a little twist from one layer to another, so that molecules are formed with a helical structure. The length of tread pitches of the helical structure is decided by the concentration of the chiral agent. Based on the particular helical structure, the cholesteric liquid crystals have several optical properties, such as optical rotation and selective light reflection. And, at normal incidence, the reflected light is circularly polarized. Circularly polarized light with the same rotating sense as the helical structure of the cholesteric liquid crystals is entirely reflected, while light with the opposite rotating sense is fully transmitted.

The main method for manufacturing cholesteric liquid crystals is to add a chiral agent to nematic liquid crystals with multi-layers. As mentioned above, cholesteric liquid crystals have a helical structure, and liquid crystal director axes twist around this helical axis. The helical structure can be found in some pure compounds with asymmetric molecular structures such as cholesterol derivatives.

An important property of cholesteric liquid crystals is Bragg reflection from the planar texture, because the refractive index varies with the helical axis and results in a cyclic variation.

FIG. 1 is a schematic, cross-sectional view of a display device composed of cholesteric liquid crystals. First, a substrate 10 is pressed and merged with a substrate 20. Then, cholesteric liquid crystals 30 are poured. The display device is completed as shown in FIG. 1. The molecular structure of the cholesteric liquid crystals between the substrate 10 and the substrate 20 is twisted around the helical axes wherein P₀ is a thread pitch of cholesteric crystals 30. FIG. 2 is a graph showing the effect of reflectivity R on wavelength W of the cholesteric liquid crystals as shown in FIG. 1. Referring to FIG. 2, the cholesteric liquid crystals having the thread pitch P₀ have a preferred reflectivity between n₀P₀ and nₑP₀, wherein n₀ is a refractive index for ordinary rays and nₑ is a refractive index for extraordinary rays.

Therefore, when a display device is composed of the cholesteric liquid crystals, its range of use is also limited to that wavelength. Such an application scope is not broad enough.

### SUMMARY OF THE INVENTION

In view of the foregoing need, it is therefore an objective of the present invention to provide a method and a structure for broadening the cholesteric liquid crystal spectrum. At least one electrode is added at one side of the liquid crystal display for applying an electric field, so that the thread pitches of the cholesteric liquid crystals are not uniform. Consequently, the application scope of display devices is broadened.

It is another an objective of the present invention to provide a method and a structure for broadening cholesteric liquid crystal spectrum. First, the cholesteric liquid crystals poured into substrates are enabled to polymerize by using the liquid crystal molecules having monomer structure or adding monomers into the cholesteric liquid crystals. Then, the monomers polymerize due to irradiation with appropriate light. Hence, the non-uniform thread pitched of the cholesteric liquid crystals are blocked and maintained even when no power is applied to the electrode.

In accordance with the foregoing and other objectives of the present invention, a method for broadening cholesteric liquid crystal spectrum is described as follows. Two substrates are provided, and a gap between the two substrates is filled with cholesteric liquid crystals, in which director axes of the cholesteric crystals twist around a plurality of vertical axes perpendicular to the two substrates. Next, at least one electrode structure is added at one side of one of the two substrate. Finally, a voltage is then applied to the electrode structure to produce a fringe field and to change the thread pitches of the cholesteric liquid crystals, in which the fringe field is perpendicular to directions of the vertical axes.

In a preferred embodiment of the present invention, the above-mentioned cholesteric liquid crystals are further enabled to polymerize. So after changing the thread pitch of the cholesteric liquid crystals by applying a voltage, polymerization is performed by irradiation with a ray. The thread pitch of the cholesteric liquid crystals is thus blocked. A cholesteric crystals having a monomer structure can be polymerized, or monomers can be added to the cholesteric liquid crystals to allow polymerization. The preferred monomers can be liquid crystal monomers, chiral monomers, photoinitializer monomer or mixtures thereof. The preferred ray is an ultraviolet ray or Ar ray.

The preferred electrode structure is coplanar, having staggered positive and negative electrodes. The voltage can be provided by an alternating current or a direct current. If the director axes of the cholesteric liquid crystals twist around a direction perpendicular to the substrates, the preferred fringe field will be also perpendicular to the direction. The electrode structure can be formed on the same side as or a different side from the cholesteric liquid crystals.

The display device of the present invention comprises the following: a first substrate and a second substrate; cholesteric liquid crystals located between the first substrate and the second substrate; and a electrode structure located between the cholesteric liquid crystals and the first substrate, in which the electrode structure has a capability of producing a fringe field.

The present invention broadens the cholesteric liquid crystal reflective spectrum, so that the application scope of a display device comprising the cholesteric liquid crystal, such as a liquid crystal display, brightness enhancement films for liquid crystal display, a circular polarizer with full spectrum or smart window, also increases,

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic, cross-sectional drawing of a display device composed of cholesteric liquid crystals;

FIG. 2 is a graph showing the effect of reflectivity R on wavelength W of the cholesteric liquid crystals as shown in FIG. 1;

FIG. 3 is a schematic, cross-sectional drawing of a display device composed of cholesteric liquid crystals, according to the present invention;

FIG. 4 is a schematic, cross-sectional drawing of an electrode structure producing a fringe field, according to one preferred embodiment of the present invention;

FIG. 5 is a schematic, vertical view of the structure as shown in FIG. 4;

FIG. 6 is a schematic, vertical view of the structure as shown in FIG. 4;

FIG. 7 is a schematic, cross-sectional drawing of an electrode structure producing a fringe field, according to another preferred embodiment of the present invention; and

FIG. 8 is a schematic, cross-sectional drawing of an electrode structure producing a fringe field, according to still another preferred embodiment of the present invention.

FIG. 9 is a graph showing the effect of reflectivity R on wavelength W of the display device comprised of cholesteric liquid crystals, according to the present invention;

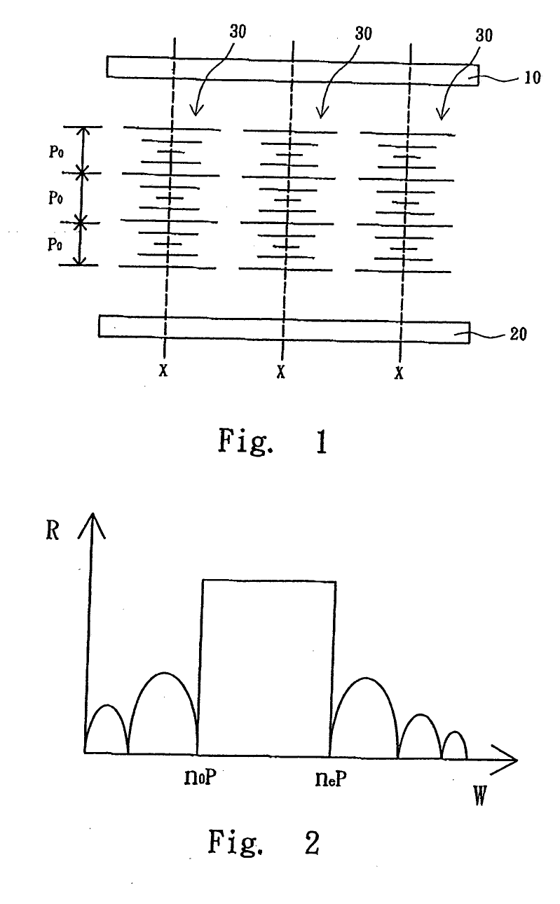

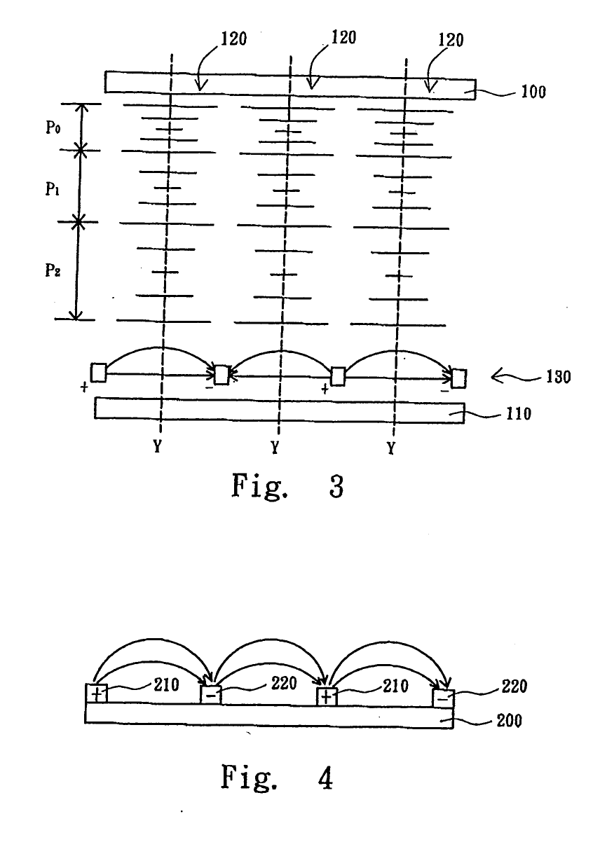

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The manufacturing method and the structure of the present invention are described in the following.

First, a substrate is provided, and spacers are disposed on the substrate. Next, another substrate is provided and merged onto the substrate, so that some vacant space exists because of the spacers between the two substrates. The two substrates are sealed by a sealant, and the sealant is hardened after irradiation by appropriate ray. Then, the vacant space between the two substrates is filled with cholesteric liquid crystals and a basic display device is completed. One characteristic of the present invention is the addition of an electrode structure at one side of one of the substrates, so as to provide a fringe field. The fringe field varies the length of thread pitches of the cholesteric liquid crystals located between the substrates. The electrode structure can be located on the inner side of one substrate; that is, between the cholesteric liquid crystals and one substrate.

In addition to the above-mentioned method, there are several other methods of filling the vacant space between the two substrates the cholesteric liquid crystals. For example, first, the two merged substrates are vacuumed and placed in cholesteric liquid crystals. Then, the vacuum state of the substrates is broken and the cholesteric liquid crystals fill between the substrates due to atmospheric pressure. In another possible example, cholesteric liquid crystals are placed on one substrate, and another substrate is then merged thereon. Sealant is coated between the two substrates and hardened after irradiation with an appropriate ray.

The foregoing processes are examples, and the steps, such as merging substrates, disposing spacers, sealing and irradiating, are known to persons skilled in the art. Therefore, these steps are not described in detail, and are not limited by the present invention.

FIG. 3 is a schematic, cross-sectional drawing of a display device composed of cholesteric liquid crystals according to the present invention. A substrate 100 and a substrate 110 of the display device are separately located at the top and bottom sides. The cholesteric liquid crystals 120 are located between the substrate 100 and the substrate 110. An electrode structure 130 is located between the substrate 110 and the cholesteric liquid crystals 120.

The electrode structure 130 is composed of positive and negative electrodes in a staggered arrangement. When a voltage is applied to the electrode structure 130, an electrical field perpendicular to the Y axis is produced between the positive electrodes and the negative electrodes, as shown by arrows between the positive and negative electrodes in FIG. 3. The electrical field is not uniform. When closer to the electrode structure 130, the electrical field is stronger. Similarly, when farther from the electrode structure 130, the electrical field is weaker. The electrical field having such a property is also called fringe field. The cholesteric liquid crystals 120 are affected by the electrical field produced by the electrode structure 130. The thread pitches of cholesteric liquid crystals located nearer the electrode structure 130 are lengthened more because of the stronger electrical field. On the other hand, the thread pitches of cholesteric liquid crystals located farther from the electrode structure 130 are lengthened less because of the weaker electrical field.

As shown in FIG. 3, the director axes of the cholesteric liquid crystals twist around the Y axes, and the cholesteric liquid crystals includes several thread pitches, P₀, P₁ and P₂, in which P₁ is larger than P₀, and P₂ is larger than P₁. This is due to the fringe field.

FIG. 3 is an illustration only, and the amount of electrodes and the cholesteric liquid crystals and change in degree of thread pitches are examples and not limiting of the present invention.

The electrode structure 130 can be located on the substrate 100 or the substrate 120. In addition, besides being formed on the substrate directly, the electrode structure can be formed separately, and then added between the substrate and the cholesteric liquid crystals. The preferred electrode structure 130 is a coplanar structure. The several embodiments of the electrode structure are described in the following and illustrated in FIGS. 5 to 9.

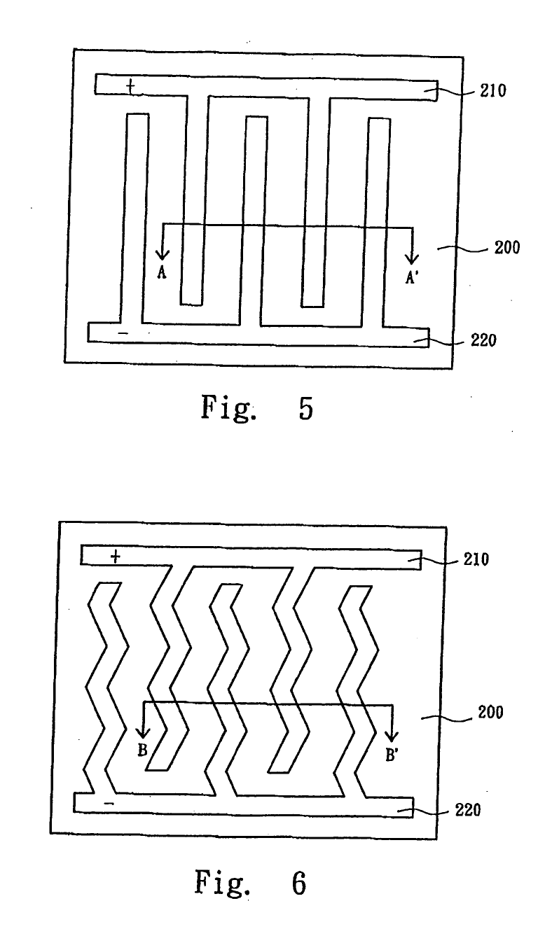

Referring to the cross-sectional structure illustrated in FIG. 4, a substrate 200 is comprised of glass or plastics. An electrode 210 and an electrode 20 are formed with a staggered arrangement on the substrate 200 by an evaporation or etching process. The electrode 210 and the electrode 220 are comprised of transparent conductive material such as indium tin oxide (ITO), and the electric properties are decided by an externally applied voltage. For example, when using a voltage supplied by a alternating current, the electric properties of the electrode 210 and the electrode 220 are alternated.

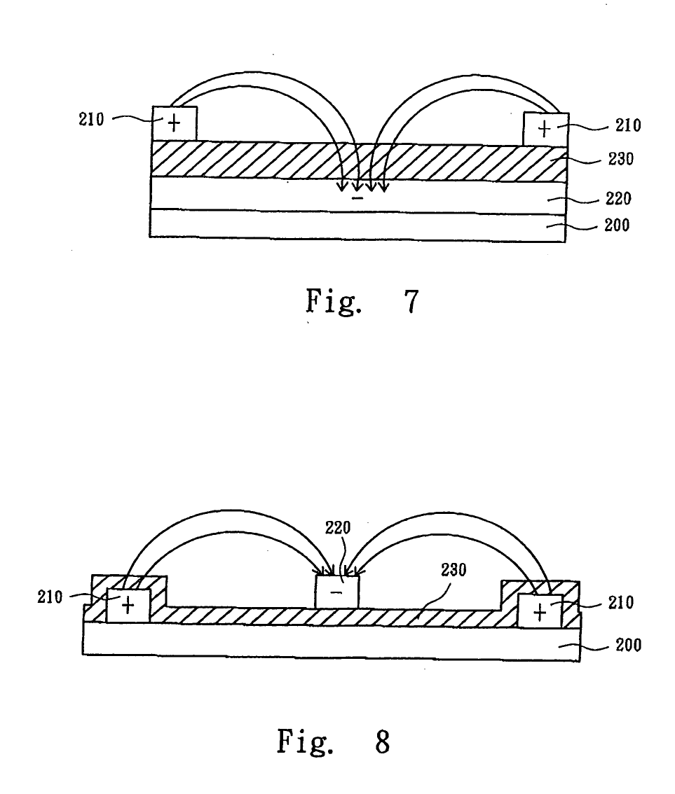

In the structure of FIG. 5 and FIG. 6, the electrode 210 and the electrode 220 are finger shaped, wherein the finger shape of the electrode in FIG. 5 is long-bar, but the finger shape of the electrode in FIG. 6 is a crooked-bar. The effect of the present invention is unchanged whether the long-bar finger shape of FIG. 5 or the crooked-bar finger shape of FIG. 6 is used. From the view of a hatch A-A′ in FIG. 5 or a hatch B-B′ in FIG. 6, the cross-sectional electrode structure with a staggered arrangement is illustrated in FIG. 4 and produces a fringe field such as the electrode structure 130 of FIG. 3. The patterns of the electrode 210 and the electrode 220 are determined by photolithography.

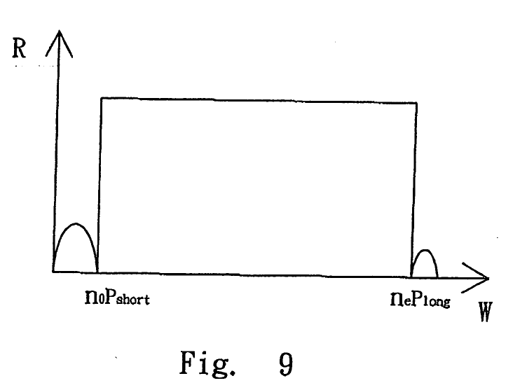

The electrode structure producing the fringe field as shown in FIG. 4 can be the structure shown in FIG. 7 and FIG. 8.

Referring to FIG. 7, an electrode 220 is formed on a substrate 200. Next, a insulating layer 230 is formed thereon, to insulate two electrodes. Then, an electrode 210 having intervals is formed on the insulating layer 230. When a positive voltage is applied to the electrode 210 and a negative voltage is applied to the electrode 220, a fringe field is formed between the electrode 210 and the electrode 220. The location is nearer the electrode 210 and the electrode 220, and the electrical field is stronger.

Referring to FIG. 8, first, an electrode 210 having intervals is formed on a substrate 200. Next, a insulating layer 230 is formed to cover the electrode 210 and the substrate 200. Then, an electrode 220 is formed between the intervals of the electrode 210. When a positive voltage is applied to the electrode 210 and a negative voltage is applied to the electrode 220, a fringe field is formed between the electrode 210 and the electrode 220. The location is nearer the electrode 210 and the electrode 220, and the electrical field is stronger.

In the electrode structure of FIGS. 4 to 6, the positive electrode and the negative electrode are coplanar. In the electrode structure of FIG. 7 and FIG. 8, there is almost no drop between the positive electrode and the negative electrode, so it can be regard as coplanar. The coplanar electrode structure results in a uniform effect on the cholesteric liquid crystals for a display device. The above-mentioned electrode structures are examples. Either a coplanar electrode or a non-coplanar electrode can be used in the present invention if only a fringe field is produced to vary the thread pitches of the cholesteric liquid crystals.

The foregoing method and structure of the present invention can produce cholesteric liquid crystals having various thread pitches, and the reflective spectrum is also increased. FIG. 9 is a graph showing the effect of reflectivity R on wavelength W of the display device comprised of cholesteric liquid crystals according to the present invention. Referring to FIG. 9, the reflective spectrum of the cholesteric liquid crystals increases to between n₀Pₛₕₒᵣₜ to nₑP_{long}, where n₀ is a refractive index for ordinary rays, nₑ is a refractive index for extraordinary rays, Pₛₕₒᵣₜ is the shortest thread pitch of cholesteric liquid crystals and P_{long} is the longest thread pitch of the cholesteric liquid crystals.

The thread pitches of cholesteric liquid crystals are varied because of the electrical field. If no voltage is applied to the electrodes, no electric field exists, and the various thread pitches of cholesteric liquid crystals are not maintained. Therefore, in another embodiment of the present invention, a method is disclosed to maintain the various thread pitches of cholesteric liquid crystals.

First, the cholesteric liquid crystals are enabled to have a capability to self-polymerize by using a monomer material having polymerizing capability to form cholesteric liquid crystals. For example, the method of manufacturing cholesteric liquid crystals is to add a chiral dopant into a nematic host, so that molecules of liquid crystals or a chiral agent having polymerizing capability is used to polymerize the cholesteric liquid crystals. Alternatively, after forming cholesteric liquid crystals, at least one monomer, such as a liquid crystal monomer, chiral monomer, photoinitializer monomer or mixtures thereof, is added to the cholesteric liquid crystals. By using the foregoing method, the cholesteric liquid crystals 120 located between the substrate 100 and the substrate 110 as shown in FIG. 3 would have a polymerizing capability.

Then, a voltage is applied to the electrode structure 130 of FIG. 3 so as to provide a fringe field. The length of the thread pitches of cholesteric liquid crystals is varied. By using a ray having appropriate wavelength and intensity, preferably an ultraviolet ray or an Ar ray, the cholesteric liquid crystal polymerizes. The various thread pitches of cholesteric liquid crystals are blocked and maintained.

The method of the present invention can form electrodes on the substrates first, and then apply a voltage to the electrodes so as to vary the thread pitches of the cholesteric liquid crystals. Alternatively, the substrate are merged and filled with cholesteric liquid crystals, first, and then an external electric field is provided to vary the thread pitches of the cholesteric liquid crystals. Finally, a ray is used to block the thread pitches of the cholesteric liquid crystals.

The advantages of the foregoing method and structure of the present invention broaden the application scope of the cholesteric liquid crystals due to the ability to change the gradient of the thread pitches and to maintain the various thread pitches by adding the monomers and irradiation.

The cholesteric liquid crystal device manufactured by using the method of the present invention can be used for liquid crystal displays, brightness enhancement films for liquid crystal displays, circular polarizers with full spectrum or smart windows for resisting sunlight. The smart window allows some light with a particular wavelength to transmit or reflect, decided by the different thread pitches of the cholesteric liquid crystal. For example, when it is hot, the smart window could reflect ultraviolet or infrared, and when it is cold, the smart window could transmit ultraviolet or infrared. Thread pitches of cholesteric liquid crystals in the smart window would determine the choice of ultraviolet or infrared to be transmitted or reflected

As is understood by a person skilled in the art, the foregoing preferred embodiment of the present invention is illustrative rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for broadening a spectrum of cholesteric liquid crystal, comprising:
providing a first substrate and a second substrate, and sealing the two substrates by a sealant;
filling cholesteric liquid crystals between the first substrate and the second substrate, wherein director axes of the cholesteric crystals twist around a plurality of vertical axes perpendicular to the first and the second substrates;
forming at least one electrode on one side of the first substrate; and
applying a voltage on the electrode to produce a fringe field, so as to change thread pitches of the cholesteric liquid crystals, wherein the fringe field is perpendicular to directions of the vertical axes.

2. The method according to claim 1, further comprising:
enabling the cholesteric liquid crystals to polymerize; and
after the step of changing the thread pitches of the cholesteric liquid crystals, irradiating the cholesteric liquid crystals with a ray, so as to perform a polymerization.

3. The method according to claim 2, wherein the enabling step is provided by at least one monomer of the cholesteric liquid crystal, and the monomer which is selected from a liquid crystal monomer, chiral monomer, photoinitializer monomer and mixtures thereof.

4. The method according to claim 1, wherein the ray is an ultraviolet ray or an Ar ray.

5. The method according to claim 1, wherein the electrode has a coplanar structure.

6. The method according to claim 1, wherein the electrode has at least one positive electrode structures and at least one negative electrode structures with a staggered arrangement.

7. The method according to claim 1, wherein the voltage is provided by alternating current or direct current.

8. The method according to claim 1, wherein the electrode is located on the same side of the first substrate as the cholesteristic liquid crystal, and located between the cholesteric liquid crystal and the first substrate.

9. The method according to claim 1, wherein the electrode is located on a different side of the first substrate from the cholesteristic liquid crystal.

10. A method for broadening a spectrum of cholesteric liquid crystal spectrum, comprising:
forming a electrode structure on a first substrate;
merging the first substrate and a second substrate and sealing the two substrates by a sealant;
filling cholesteric liquid crystals between the first substrate and the second substrate, wherein the electrode structure is located between the first substrate and the cholesteric liquid crystals; and
applying a voltage to the electrode structure to produce a fringe field, so as to change thread pitches of the cholesteric liquid crystals.

11. The method according to claim 10, further comprising:
enabling the cholesteric liquid crystals to polymerize; and
after the step of changing the thread pitches of the cholesteric liquid crystals, irradiating the cholesteric liquid crystals with a ray, so as to perform a polymerization.

12. The method according to claim 11, wherein the enabling step comprises adding at least one monomer to the cholesteric liquid crystal.

13. The method according to claim 12, wherein the monomer is selected from a liquid crystal monomer, a chiral monomer, a photoinitializer monomer and a mixture thereof.

14. The method according to claim 12, wherein the ray is an ultraviolet ray or a Ar ray.

15. The method according to claim 10, wherein the voltage is provided by alternating current or direct current.

16. The method according to claim 10, the steps of forming the electrode structure comprising:
forming a first electrode on the first substrate; and
forming a second electrode on the first substrate, wherein the first electrode and the second electrode are staggered in arrangement, and the first electrode and the second electrode have opposite electric properties.

17. The method according to claim 16, wherein the first electrode and the second electrode are finger shaped.

18. The method according to claim 10, the steps of forming the electrode structure comprising:
forming a first electrode on the first substrate;
forming an insulating layer on the first electrode; and
forming a second electrode on the insulating layer, wherein the second electrode partially exposes the insulating layer and the first electrode and the second electrode have opposite electric properties.

19. The method according to claim 18, wherein the first electrode is partially exposes the first substrate.

20. A LCD display device of cholesteric liquid crystal, comprising:
a first substrate;
a second substrate;
cholesteristic liquid crystal located between the first substrate and the second substrate; and
an electrode structure located between the cholesteric liquid crystal and the first substrate, and having a capability of producing a fringe field.

21. The LCD display device according to claim 20, wherein the cholesteric liquid crystals have various lengths of thread pitches.

22. The LCD display device crystal according to claim 20, wherein the electrode structure is formed on the first substrate.

23. The LCD display device according to claim 20, wherein the electrode structure comprises:
a first electrode located on the first substrate; and
a second electrode located on the first substrate, wherein the first electrode and the second electrode have a staggered arrangement, and the first electrode and the second electrode have opposite electric properties.

24. The LCD display device according to claim 20, wherein the first electrode and the second electrode are finger shaped.

25. The LCD display device according to claim 20, wherein the electrode structure comprises:
a first electrode located on the first substrate;
a insulating layer located on the first electrode and the first substrate; and
a second electrode located on the insulting layer, wherein the first electrode and the second electrode have opposite electric properties.

26. The LCD display device according to claim 25, wherein the first electrode partially exposes the first substrate.
